(19) United States
(12) Patent Application Publication
(10) Pub. No.: US 2021/0026687 A1
(43) Pub. Date: Jan. 28, 2021

(54) COMPUTER-IMPLEMENTED SYSTEM AND METHODS FOR COMPUTING VALUATION

(71) Applicant: Castalune LLC, Reading, MA (US)

(72) Inventors: Robert Miller, Reading, MA (US); Zachary Power, Jamaica Plain, MA (US); Angelica Zilli Machado, Charlestown, MA (US)

(73) Assignee: Castalune LLC, Reading, MA (US)

(21) Appl. No.: 17/023,786

(22) Filed: Sep. 17, 2020

Related U.S. Application Data
(60) Provisional application No. 62/878,896, filed on Jul. 26, 2019.

(51) Int. Cl. G06F 9/48; G06F 9/50

(52) U.S. Cl. CPC G06F 9/4881; G06F 9/505; G06F 9/5038; G06F 9/5072

(57) ABSTRACT

A computer implemented computing valuation system may include: a job submitter providing a compute job result request; a plurality of compute job resources each having one or more computing properties; and processor logic that may be configured to: divide the compute job result request into a plurality of computing tasks; create an execution plan which maps each computing task to one or more compute job resources based on one or more of their respective computing properties; assign a resource cost to each computing task and compute the total of all the resource costs; provide a job cost to the job submitter; dispatch the plurality of computing tasks to the mapped compute job resources; receive task results from the mapped compute job resources; collate the task results into a compute job result; validate the compute job result; and provide the compute job result to the job submitter.

### CROSS REFERENCE TO RELATED APPLICATIONS

This application claims priority to and the benefit of the filing date of U.S. Provisional Application No. 62/878,896, filed on Jul. 26, 2019, entitled “A SYSTEM AND METHOD FOR MONETIZING A MULTI-FUNCTIONAL DISTRIBUTED COMPUTING AND DATA PROCESSING NETWORK”, which is hereby incorporated by reference in its entirety.

### FIELD OF THE INVENTION

This patent specification relates to the field of decentralized computing. More specifically, this patent specification relates to a system and methods for monetizing computing performed by computing devices in a decentralized computing network.

### BACKGROUND

Current State of Centralized Cloud Computing

The growth in data collection capabilities has resulted in significant increases in the volumes of data that organizations can access and evaluate, often referred to as “big data”. The commercial insights obtained through analysis and manipulation of said large datasets create material competitive advantages. To meet this market demand, technology companies have constructed large-scale datacenters consisting of tens of thousands of individual computer servers to address this issue. This centralized cloud computing foundation has allowed organizations to outsource much of their hardware requirements, as they can contract the third party to operate multiple computers while still benefitting from its use through software, paying for the compute time in which the computers are put to work.

Such a centralized framework for computing also presents challenges for the overall flexibility of the cloud, security and availability of data stored in limited locations, and the computational efficiency and availability that the network can exhibit. These barriers create a fundamental limitation to the various kinds of analyses that can be conducted in a commercial setting. Whenever there are few large players this presents barriers to an efficient market until there is some disruption to disintermediate those large players. Until that time the price of services can be inflated without free market correction. This is especially challenging for organizations seeking to conduct advanced analytical manipulations of large datasets to identify and evaluate potential trends, patterns, and other valuable insights, and to do so in an increasingly timely and cost-effective manner. The compute time and associated financial cost of the centralized cloud computing framework does not sufficiently support exploratory research and innovation. Without reducing cost innovation will be restricted. This is a fundamental barrier for unlocking the value that the availability of big datasets represents. As the volume of data continues to grow, the centralized framework will not provide the flexibility required by organizations. Many technology providers are therefore planning around the ‘edge’, which is a reference to being able to have smaller datacenters that are geographically placed in advantageous locations, thus moving in the direction of a decentralized framework.

Current State of Large-Scale Distributed Computing

Many organizations contract multiple computer servers located within a datacenter to perform a given analysis in parallel with one another. The more computers that are able to work in parallel with one another on a given compute job, the faster, measured in calendar time vs computer time, that compute job can be accomplished. Over the past several years new frameworks and methodologies have been created to support this initial parallelization effort. A recent example of large-scale distributed computing is the advent of Bitcoin mining, whereby individuals are able to operate software on that use the device's computing capability to solve an existing complex math problem. In the event that a computer successfully completes the problem, the system grants a Bitcoin to that user. At the start of Bitcoin, it was easy to mine coins. As coins are mined it becomes more and more difficult to mine new coins. This can be attributed to the limited number of that are coins available, as coins are “found” it is harder to find the next one. This difficulty has increased the energy and operational cost and now requires custom hardware and systems to mine coins profitably (if bitcoin value decreases it is possible that today it will not be profitable to mine new coins).

While large-scale datacenters contain many thousands of computers, it is difficult for a user of the datacenter service to: provision machines; deploy software; and execute jobs on thousands of computers. The causes for this are both physical (the number of available contracted computer types) and financial (the costs for doing so can easily be prohibitive). For these reasons, large-scale distributed computing has not been widely adopted in commercial settings outside of the temporary trend of Bitcoin mining.

However, large-scale distributed computing processes have been used by organizations for non-profit research purposes. Rather than datacenters supporting the compute jobs, individuals have volunteered their personal internet-connected devices, such as desktop computers and video game consoles, to support software-enabled distributed computing projects. In the voluntary context, the network of geographically distributed devices effectively replaces the datacenter servers to provide computing capabilities that support a portion of the collective requirements for a given compute task. This volunteer system has been used in research capacities including, but not limited to, the fields of medicine and pharmaceuticals, mathematics, and extraterrestrial life. The results have proven to be both novel and material for the advancement of knowledge in each field. However, the voluntary nature of these initiatives has impeded the widespread commercial adoption of such systems to answer business problems.

While the number of non-datacenter computing devices that are capable of supporting the manipulation of large datasets is substantial, the lack of a cohesive system to enable and compensate said device network contributors impedes the ability for such non-traditional devices to address the various commercial use cases serviced by large-scale datacenters. Simultaneously, the lack of a mechanism also leaves an unmet need in the market for true big data analysis and big data innovation. In order to enable the manipulation of large datasets in an adequately efficient manner, therefore, it is necessary to create new technology systems, pricing systems and security systems that are designed for completing a variety of compute tasks in a distributed network of traditional and non-traditional devices which are financially compensated based on the computational contribution value provided by each device for the completion of said tasks.

Current State of ‘Micro Technologies’ and Datasets

Historically, software code has been attributed value in that it is compiled together into larger applications that have full functionality. These applications can then be purchased by individuals and organizations and used in their entirety. More recently, the rise of open-source platforms for software development have enabled the widespread flow of information between developers by allowing them to share free code with one another. The available code is often less developed than a full application and represents individual commands and tasks. While this has helped broaden the availability of pre-written code, it does not provide monetary compensation for the developers who make their code available. The lack of financial support for individuals contributing lines of code reduces the incentive for them to create and improve code that may have material value for organizations. This impedes innovation, discovery and economic growth at large. Interestingly big corporations who once were against open source have benefitted by having access to open source software without compensation to developers who created it.

In parallel, the growth in data collection capabilities has provided organizations with unique datasets with value beyond use with their own organization. However, there is no ability to sell this data at fair market rates that are defined by end users because a system for the identification, organization, and pricing of said unique datasets does not yet exist. The lack of such a system limits the free flow of information among organizations and creates a disincentive for novel data collection and aggregation that can have widespread value for the economy and society.

The current system(s) for cloud computing are centrally designed (e.g. large datacenters). The cost associated with accessing large volumes of computing resources in these datacenters can be substantial, making certain forms of computationally-intensive, big data analysis cost prohibitive. This problem becomes more significant as the volume of data continues to grow (the current volume is expected to double every year going forward).

In parallel, organizations have experimented with distributed computing systems that draw on the computing resources of many thousands of disparate computers (e.g. laptops, video game consoles). The potential scalability of this design is significant in that it allows enormous amounts of computational resources to be directed at complex problems, such as genetic sequencing. However, these organizations have relied on individuals volunteering their devices out of academic or intellectual support. As such, there is no mechanism by which to (i) calculate the financial value of an individual computing device for a particular computing job and/or (ii) dispatch jobs out to a network of computing devices based on the financial value.

Therefore, a need exists for novel computer-implemented systems and methods for providing computing valuation. A further need exists for novel computer-implemented computing valuation systems and methods that utilizes ubiquitous data access and the ability to have custom processing of any available or custom generated data set. Still a further need exists for computer-implemented computing valuation systems and methods that are configured to (i) calculate the financial value of an individual computing device for a particular computing job and/or (ii) dispatch jobs out to a network of computing devices based on the financial value.

### BRIEF SUMMARY OF THE INVENTION

The invention pertains to a computerized system that enables payment for individual, generally small, contributions to the processing of a distributed data analysis or data manipulation. In some embodiments, the computing valuation system may be configured to calculate, disseminate and manage the financial value of disparate hardware computing resources that are working on a computing job.

According to one embodiment consistent with the principles of the invention, a computer implemented computing valuation system for the posting and transfer of computing jobs is provided. Preferably, the system may provide the novel capability of allowing a job submitter may pay for the results of a computing job as opposed to having to pay for the processing of those results. In some embodiments, the system may include: a job submitter providing a compute job result request; a plurality of compute job resources each having one or more computing properties; and processor logic that may be configured to: divide the compute job result request into a plurality of computing tasks; create an execution plan which maps each computing task to one or more compute job resources based on one or more of their respective computing properties; assign a resource cost to each computing task and compute the total of all the resource costs; provide a job cost to the job submitter; dispatch the plurality of computing tasks to the mapped compute job resources; receive task results from the mapped compute job resources; collate the task results into a compute job result; validate the compute job result; and provide the compute job result to the job submitter.

According to another embodiment consistent with the principles of the invention, a computer implemented computing valuation system for the posting and transfer of computing jobs may include: a job submitter providing a compute job result request; a plurality of compute job resources each having one or more computing properties; and processor logic that may be configured to: divide the compute job result request into a plurality of computing tasks; determine one or more tradeable usage rights that may be required for the compute job result request, in which each tradeable usage right has a tradeable usage right cost; create an execution plan which maps each computing task to one or more compute job resources based on one or more of their respective computing properties; assign a resource cost to each computing task and compute the total of all the resource costs; provide a job cost to the job submitter, the job cost including the total of all the resource costs and the tradeable usage right costs of the one or more tradeable usage rights; dispatch the plurality of computing tasks to the mapped compute job resources; receive task results from the mapped compute job resources; collate the task results into a compute job result; validate the compute job result; and provide the compute job result to the job submitter.

In further embodiments, the system may provide an electronic exchange marketplace system to determine the fair value for data to be defined, created, purchased and sold, and the system may include: a system for submission to a clearinghouse for approval, validation and preparation for marketplace usage; a system for approval that requires adequate security thresholds have been met, the actual functionality of the code reflects the stated function and performance metrics are established; a system for approval that the data contributor has legal rights to distribute the data within the marketplace system; a system to securitize the data through fracturing, anonymizing and encoding among a network of distributed devices; a system for the display of trends in the data used; a system for the distribution of different datasets that can be stored and manipulated within device clusters without having the data transferred to a central location; a system for datasets is made available for use, purchase and aggregation to eligible participants; and a system to publish data metrics and data exchange metrics to support the fair trade of data.

In further embodiments, the system may provide an electronic exchange marketplace to determine the fair value for software modules or algorithms or any other basic technology component that does not constitute a standalone application to be defined, created, purchased and sold, and the system may include: a system for submission to a clearinghouse for approval, validation and preparation for marketplace usage; a system for approval that requires adequate security thresholds have been met, the actual functionality of the code reflects the stated function and performance metrics are established; a system for the validation of intended use, data requirements and manipulation parameters; a system that creates tradeable usage rights based on successful validation; compute job resources are able to purchase usage rights in manual or automated processes; system for deployment of software modules to eligible compute job resources; a system that allows for pricing to be determined by the marketplace system, calculated based on the expected near-term demand for the module characteristics, or a process that allows participants to bid against one another; and a system to publish module metrics and module exchange metrics to support the fair trade of modules.

In further embodiments, the system may provide an electronic exchange marketplace to determine the fair value for distributed computing devices and capacity to be identified defined, purchased and sold, and the system may include: processes to identify and dispatch computing jobs to devices and clusters of devices by checking device and network availability, characteristics, economic value, topology and traits as individual devices and clusters of devices based on the requirements of the current or expected future computing jobs and client preferences; a variable pricing system informed by device payment/price, compute time, compute capability, geographic location, internet connection, reliability, traits of the compute job resource owner (contributor user) such as age, employment, and gender; a system to enable individual devices and clusters of compute job resources to communicate directly with one another to identify, define and complete compute jobs; a system to calculate an economic value for each compute job resource and compute job resources-cluster based on different payment methodologies, such as competition system, per hour of availability, donation, compute job type, discounted devices or services, among others; dispatches the computing tasks to the network of compute job resources (traditional and non-traditional internet-connected devices) and monitors for completion of task, failure, and reassigns the computing traffic in order to best meet the requirements of the job submitter (compute buyer) including time, cost, and compute job resource traits such as location; a payment system including direct cash via wireless banking transfer, donation to third parties, cryptocurrency transfers, and ownership interests in data, software modules or individual algorithms; a system to implement rules and functionality governing the way in which exchange participants can obtain the benefits provided in the payment systems, such as a threshold of value required to be reached prior to the ability to extract the form of payment (e.g. $1,000 before cash can be withdrawn, but can donate any amount before then); descriptions, labels, suggested uses, rankings and other metrics for the securities which are customized and related to each marketplace participant; portfolio management services and tools that provide diagnostics, recommendations, alerts, and trading algorithms for the participation of compute job resources within the marketplace; generates summary (leaderboard/dashboard/reports) and suggestions for the compute job resources that are used to inform or change the way compute job resource owners operate their compute job resources or participate in the computing platform and exchange (total payments, payments by compute job resources type, payment methodology, by geography, ‘recommendations for you’, marketplace for compute job resources); generates summary (leaderboard/dashboard/reports) and suggestions for the compute clients that are used to inform or change the way compute clients direct their computational requirements or participate in the computing platform and exchange (total payments, payments by device type, payment methodology, by geography, ‘recommendations for you’, marketplace for devices); and pattern recognition methodology within a distributed network of traditional and non-traditional compute job resources.

In still further embodiments, the system may provide an electronic exchange marketplace that automatically calculates the fair market value for data analysis, datasets and computing resources. The system may receive a compute job result request from a job submitter that includes requests and user preferences, including the compute job resources allowed to participate in user's computing job. The system may request job submitter to define payment settlement. Example payment mechanisms may include a fixed rate per time of use, a fixed rate per time of availability or other. The system may present job submitter user with a list of potential analyses to perform and a list of datasets that can be used in the analyses. If the system does not have the analysis and/or datasets desired by job submitter, the system enables the job submitter to request the analysis and/or datasets from other usage right resources or market participants of a developer network). If the job submitter sees what they want, the job submitter selects the dataset(s) and/or analyses. The system may then present job submitter with a job cost that may optionally be an estimate of pricing and time required for the system to generate a compute job result that may be calculated based on the type of analyses, data sets selected by user, similar historical analyses, available computing device metrics, computing device fee(s), and user requirements (time). The system may then present job submitter with option to alter the user preferences. If the user preferences are changed, the system updates the job cost. If no changes are made, the system requests approval from user job submitter the dispatching of the analysis or computing of the compute job result request. If the system does not receive approval, the system does not dispatch the computing job. If system receives approval, the system sends computing tasks and information describing the data analysis, data sets, pricing and performance parameters to compute job resources 108 that may be exchange participants supplying computing power (distributed computing network). The system receives signals from compute job resources 108 of the distributed computing network that they intend to participate in the completion of the analysis through the provision of computing resources. If there are not any participants in the Distributed Network that will participate in the analysis, the system notifies job submitter. The system may then present to job submitter suggested alterations to the price, time, data or analysis that might increase the participation of the compute job resources 108. The system preferably may define clusters of compute job resources that have signaled an interest in participating based on characteristics including, but not limited to, location, ownership, and processing power.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a block diagram of some of the components and computer implemented methods which may be found in a computing valuation system according to various embodiments described herein.

FIG. 2 illustrates a block diagram showing an example of a server which may be used by the system as described in various embodiments herein.

FIG. 3 shows a block diagram illustrating an example of a client device which may be used by the system as described in various embodiments herein.

FIG. 4 depicts an illustrative example of some of the components and computer implemented methods which may be found in a computing valuation system according to various embodiments described herein.

FIG. 5 shows a block diagram illustrating some components of an example of a system database according to various embodiments described herein.

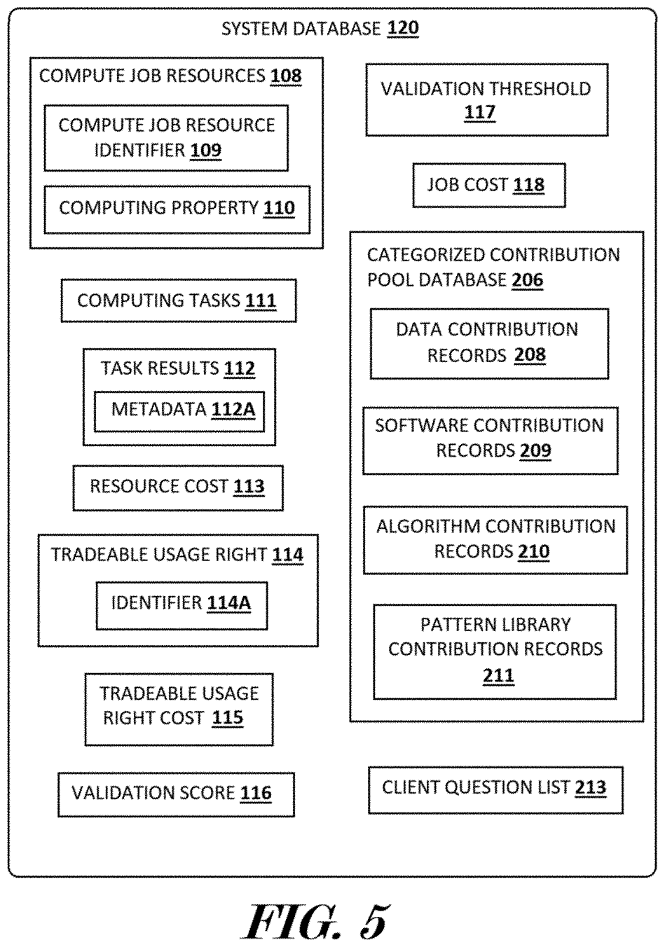

FIG. 6 illustrates some exemplary system components which may be used to provide contribution registration for contributions provided by a compute job resource according to various embodiments.

FIG. 7 depicts some exemplary system components which may be used to provide one or more supported analytic request lists of client questions according to various embodiments.

FIG. 8 illustrates some exemplary system components which may be used to provide to provide client job configuration and computing job pre-processing according to various embodiments.

FIG. 9 shows a flow diagram that a client job optimizer software engine may perform to generate ranked computing job execution plans according to various embodiments.

FIG. 10 depicts a flow diagram that a job processor software engine may perform to generate compute job results or answers and publicly viewable job metrics according to various embodiments.

FIG. 11 illustrates a flow diagram of an example process that a marketplace engine may use to determine or receive indications of interest (IOI) from compute job resources for generating a task results for a compute job result and to determine a price for the computing job results according to various embodiments.

FIG. 12 shows a flow diagram of an example process that a marketplace engine may use to determine a cost for generating a compute job result for a compute job result request according to various embodiments.

FIG. 13 depicts a flow diagram of an example process that a marketplace engine may use to register tradeable usage rights which may be used by one or more compute job resources for the generation of task results according to various embodiments described herein.

FIG. 14 illustrates a block diagram of an example of a computer-implemented method for providing a job cost and a validated compute job result to a job submitter according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the terms “computer” and “computing device” refer to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anota digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include WIFI and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigbee network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer-implemented computing valuation systems and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

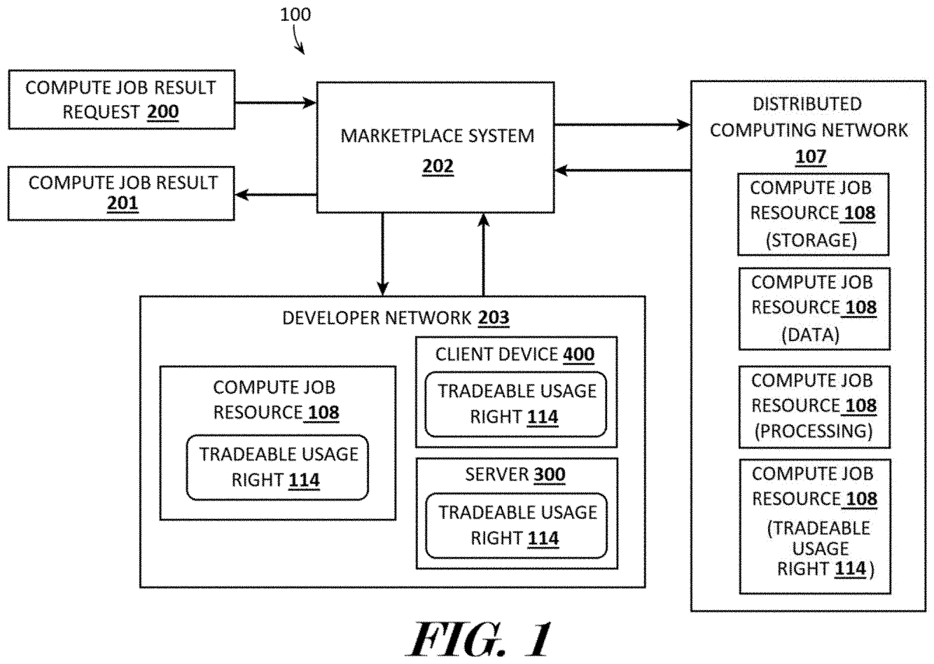

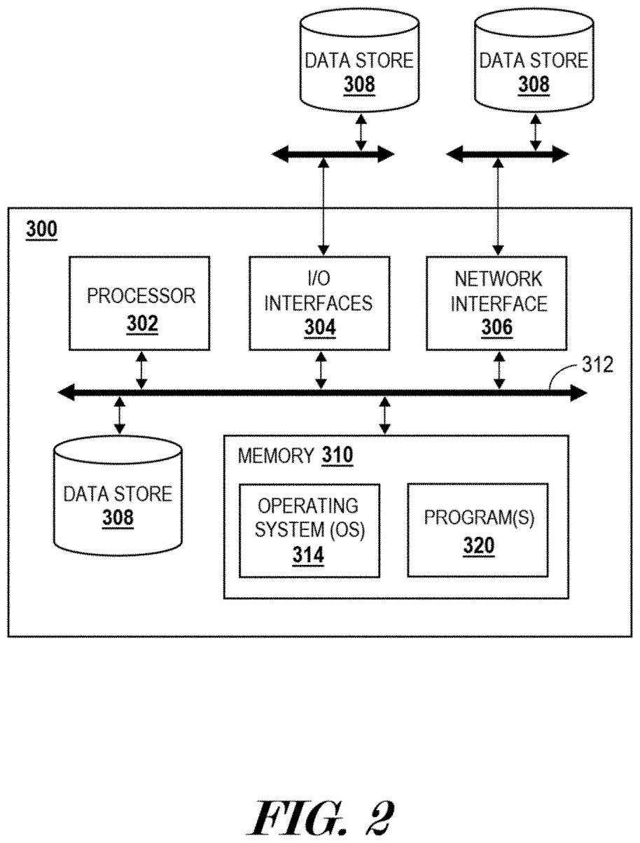

The present invention will now be described by example and through referencing the appended figures representing preferred and alternative embodiments. As perhaps best shown by FIGS. 1 and 2, an illustrative example of some of the physical components which may comprise a computing valuation system (“the system”) 100, according to some embodiments, is presented. The system 100 may provide for monetizing a network of traditional, and non-traditional, computing devices, such as severs 300 and client devices 400, for the completion of various computing tasks. The system 100 is configured to facilitate the transfer of data and information between one or more access points 103, client devices 400, and servers 300 over a data network 105. Each client device 400 may send data to and receive data from the data network 105 through a network connection 104 with an access point 103. A data store 308 accessible by the server 300 may contain one or more databases.

In this example, the system 100 comprises at least one client device 400 (but preferably more than two client devices 400) configured to be operated by one or more contributor users 101A, usage right resources 101B, and job submitters 102. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 400 and/or server 300 programmed to perform one or more of the steps described herein. In some embodiments, more than one client device 400 and/or server 300 may be used, with each being programmed to carry out one or more steps of a method or process described herein.

The system 100 may comprise one or more compute job resources 108 which may comprise any type of computing device, such as a client device 400 that may include computers, smartphones, servers 300, storage, or data sets, algorithms, computing logic. etc., that performs a portion of the distributed computing of a compute job result request 200 to provide compute job results 201. Compute job result requests 200 may be provided by the buyer or job submitter 102 and may contain data that describes what computing/data manipulation the job submitter 102 is looking for. Generally, a compute job result 201 may be the result that is outputted by the system 100 for the job submitter's 102 compute job result request 200. Computing tasks 111 may comprise tasks (unit of work) assigned to the compute job resources 108, and the computing tasks 111 may be generated by the system 100 dividing a compute job result request 200 into a plurality of computing tasks 111. Compute job resources 108 may comprise any type of computing device, such as a client device 400, server 300, data storage device or system, data/database(s), and IP components (tradeable usage rights 114 backed compute job resources 108). Task results 112 may comprise computing results that may be provided by compute job resource 108 upon processing or fulfilling their computing tasks 111. Generally, the system 100 may receive task results 112 from one or more compute job resources 108, and the system 100 may collate the task results 112 into a compute job result 201 which may then be provided to the job submitter 102 that provided the compute job result request 200 that generated the computing tasks 111.

In preferred embodiments, the system 100 enables payment for individual, generally small, contributions to the processing of a distributed data analysis or data manipulation by one or more compute job resources 108 of a contributor user 101A. The system 100 may include a plurality of contributor users 101A that make all or portions of the computing power of their compute job resource 108, which may include any type of device 300, 400, available to the system 100 as contributions. Contributions may be referred to as task results 112 which may include, but are not limited to supplying data, supplying software modules or algorithms, supplying devices to process work. Compute job resources 108 may comprise any type of computing device that may provide these contributions and may include any machine that is able to execute software, process data or answer analytic questions, such as servers 300 and client devices 400 that may include workstations, laptops, phones, video game consoles, watches, cars, smart TVs, smart appliances, or any other device that has a CPU, GPU or “XPU” (where XPU refers to a variation or new kind of processing unit). If a contributor user 101A (person/animal) has an interface to the system 100, such as a phone or other computing device 300, 400, and can be presented with analysis tasks then the contributor user 101 is considered to be another compute job resource 108 available on the system 100.

The system 100 may include a distributed computing network 107 of compute job resources 108, such as a network of computing devices 300, 400, and enables the registration and validation of any computing contribution made by a computing device 300, 400. On registration capabilities of each compute job resource 108 are also recorded. These capabilities, such as device type or data type, are used to create the optimal execution plan for any future submitted job. In the case of a non-traditional compute job resource 108, such as phones, video game consoles, watches, cars, other capabilities are recorded over time, such as a profile of when the compute job resource 108 is available for processing and a profile of where the compute job resource 108 generally is located in the distributed computing network 107. All capabilities of all compute job resource 108 are used to determine the optimal execution plan for a compute job result request 200 by the system 100.

In some embodiments, the system 100 provides functionality to allow for any custom job to be submitted as a compute job result request 200 by a job submitter 102. A job submitter 102 may comprise a buyer or entity that provides a compute job result request 200 and receives compute job result 201 in exchange for providing compensation to the system 100. If data and modules exist to satisfy the compute job result request 200, the job can be divided into a plurality of computing tasks 111 which are then dispatched to one or more compute job resources 108. The compute job resources 108 may perform the computing tasks 111 to generate task results 112, and the task results 112 may be combined by the system 100 to generate a compute job result 201 that satisfies the compute job result request 200 that may then be provided to the job submitter 102. If the data and or modules do not exist, a bid for contribution is created and published to any contributor user 101A and/or usage right resources 101B who might be able to provide data or modules for a system calculated fee. When a compute job result request 200 for a computing job is submitted that can be dispatched, the system 100 analyzes the available contributions and computes a price for the computing job and the corresponding payments to users 101A, and resources 101B, for all of the contributions needed to process the computing job. Individual computing tasks 111 are optimized to best satisfy the requirements of the computing job. For example, compute job resources 108, in one part of a country could be targeted to reduce latency of data transfer. Once the computing job is completed all contributions or task results 112 are eligible for payment. This payment can take many forms: a Competition system; direct fiat or currency payment based on availability or use of contribution; a donation to a cause or charity, etc.

Contributions take different forms (listed above) and therefore can have different payment and pricing characteristics. In some embodiments, the system 100 may comprise one or more tradeable usage rights 114. A tradeable usage right 114 may comprise a data set, an algorithm, a software module, or other intellectual property that may be used by one or more compute job resources 108 to complete their computing tasks 111 and generate their task results 112. Tradeable usage rights 114 may be stored, maintained, generated, etc., on one or more servers 300 and/or client devices 400 of usage right resources 101B that may form a developer network 203. In the case of tradable usage rights 114, such as system module or system algorithm development, the system 100 supports a public exchange to allow for compute job resources 108 owners (contributor users 101A) to request and pay for tradable usage rights 114 that are owned by usage right resources 101B and that will make their compute job resources 108 more efficient/valuable, and the system 100 may be configured to control or grant electronic access, such as by granting the ability to use, and the transferability of tradable usage rights 114, preferably in exchange for providing a tradeable usage right cost 115 to the usage right resource 101B that owns the rights to the tradable usage right(s) 114. In some embodiments, the system 100 analyzes trends to recommend module upgrades to compute job resource 108 owners (contributor users 101A). Each software module may be issued “right-of-use” shares which can then be purchased and traded amongst device owners (contributor users 101A). The system 100 enables any job submitter 102 control over their compute job result request 200 (requested computing job). A compute job result request 200 of a job submitter 102 can define that work should be dispatched to a certain set of contributor users 101A. The list of contributor users 101A could be, but not limited to, those contributor users 101A that have opted as payment to a cause, those contributor users 101A that are in a certain geographic location of sociographic demographic. The price of the compute job result request 200 will be calculated based on restrictions put in place by the submitter 102.

In preferred embodiments, the system 100 enables contributor users 101A to control their contribution use that may be provided by their compute job resource(s) 108. For example, a contributor user 101A could define that their contribution is only to be used for the company that they work for. In further preferred embodiments, the system 100 provides metrics on top contributor users 101A in different categories to support the free, efficient marketplace. In further preferred embodiments, the system 100 provides metrics on job metrics in different categories to support the free, efficient marketplace.

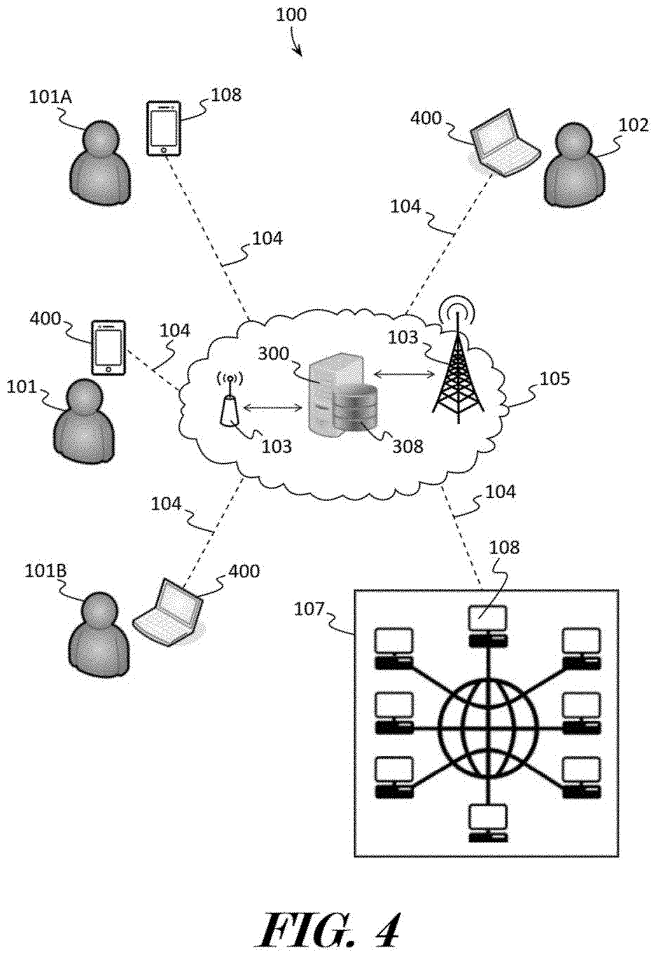

FIGS. 1 and 4 illustrate some example components of a system 100 which provide for the movement of information and signals through software systems and various types of hardware. The unique computing job is inputted to the system 100 by a job submitter 102 as a compute job result request 200 containing data defining the problem set, analysis objective, data sets, time constraints or requirements, pricing tolerances, preferred costs, and/or desired characteristics ofthe device network as selected or inputted by the job submitter 102. Alternative options may be provided by the system 100 based on machine learning of Distributed network traits. Based on this input information, the marketplace system 202 then references the individual and aggregate characteristics of the device network 107 to calculate availability and capability of the compute job resources 108 of the distributed computing network 107 to contribute to the desired computing job of the compute job result request 200. This includes evaluating if the compute job resources 108 (devices 300, 400) are connected to the internet 105, the compute job resources 108 compute capacity, network type (e.g. 4G vs. 5G), and defined preference for certain categories of computing jobs.

Data and job capabilities of compute job resources 108 may be categorized and referenced in as computing properties 110 in the system database 120, then pinged against network participants (compute job resources 108) to gauge availability. The compute job resources 108 computing properties 110 in the system database 120 is used to define and rank potential clusters of compute job resources 108 that, in aggregate, can complete the computing tasks 111 required by the compute job result request 200 within the approximate parameters originally defined. The various potential clusters of compute job resources 108 are made available in response to the compute job result request 200 for selection based on time to complete, cost and other cluster characteristics. This allows the system 100 to make informed decisions on how the compute job result request 200 will be divided into computing tasks 111 that will be dispatched to compute job resources 108 in accordance with their desires and optimal performance from the distributed computing network 107. The marketplace system 202 may output the compute job result 201 by displaying them to the job submitter 102 via their respective client device 400 in which quotes are listed for different prices and times to complete the computing job of the compute job result request 200 based on the distributed computing network 107 characteristics.

The system 100 may comprise various tradeable usage rights 114 which may comprise sources of data, algorithms and software modules that may indexed and evaluated for potential impact to complete the computing job of a compute job result request 200 within the stated parameters. A usage right resource 101B may comprise the party or entity (e.g. a human or company) that owns or grants access to a tradeable usage right 114. In some embodiments, use of tradeable usage rights 114 by one or more compute job resources 108 requires purchase of usage units, which creates a supply and demand mechanism to establish the fair market price for said dataset, software modules, and algorithms of the tradeable usage rights 114. In preferred embodiments, the system 100 may determine which tradeable usage rights 114 and which computing tasks 111 are to be performed by compute job resources 108, and these individual micro technologies (computing tasks 111 and tradeable usage rights 114) are used to inform the pricing estimates calculated in the aforementioned processes. The computing tasks 111 are dispatched to compute job resources 108 and/or the selected cluster(s) of compute job resources 108, which are monitored for compliance, availability and resiliency. Computing tasks 111 may be securitized and dispatched from the marketplace system 202 to the distributed computing network 107 based on optimizing compute job result request 200. The performance metrics are tracked and logged into a database for future reference and prediction of similar compute jobs. Compute job resource 108 characteristics, location, owner profile, etc., may be used to define clusters of compute job resources 108 with options ranked by cost and time. Compute job resource 108 or cluster failures may be re-dispatched to the queue of similarly ranked compute job resources 108 or clusters in order to produce redundancy in the system 100.

The system 100 also contains an ongoing process in which datasets, software modules and algorithms, and other tradeable usage rights 114 are submitted to the marketplace system 202 for validation, debugging, categorization, security and preparation for use within the marketplace system 202. This includes definition and quantification of tradeable usage rights 114, which is the central mechanism used to provide monetization to usage right resources 101B that may be contributors of the developer network 203. The market place system 202 may send signals and information related to the desired capability, price, and performance parameters to the developer network 203 so that one or more usage right resources 101B of the developer network 203 may use to create their tradeable usage right products. Software modules, data, algorithms, and other tradeable usage rights 114 may be submitted by the developer network 203 to the marketplace system 202 for verification, debugging, security, and duplicability. The marketplace system 202 may award units for each eligible tradeable usage right submissions and may take some portion of the units as compensation. Units may define tradeable usage rights 114 and may contribute to the marketplace system 202 value of the submitted tradeable usage right 114 items.

Referring now to FIG. 2, in an exemplary embodiment, a block diagram illustrates a server 300 of which one or more may be used in the system 100 or standalone and which may be a type of computing platform that may function as a compute job resource 108. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data.

The data store 308 is a type of memory and may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally, in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008/2012/2016 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like.

The one or more programs 320 may be configured to implement the various processes, algorithms, methods, techniques, etc. described herein.

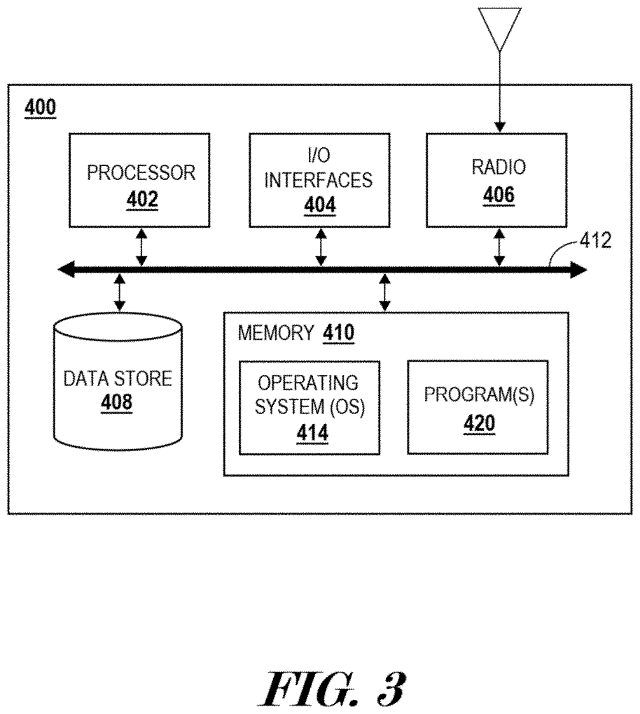

Referring to FIG. 3, in an exemplary embodiment, a block diagram illustrates a client device 400 of which one or more may be used in the system 100 or the like and which may be a type of computing platform that may function as a compute job resource 108. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display screen, such as a liquid crystal display (LCD), light emitting diode (LED) display, touch screen display, and the like. The I/O interfaces 404 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 408 may be used to store data and is therefore a type of memory. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs 420, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Microsoft Windows 10, iOS (available from Apple, Inc.), webOS (available from Hewlett Packard), Blackberry OS (Available from Research in Motion), and the like.

The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, a contributor user 101 or job submitter 102 typically uses one or more of the programs 420 along with a network 105 to manipulate information of the system 100.

The system 100 may comprise one or more databases, such as a system database 120, which may be stored on a data store 308. It should be understood that the described structure of the system database 120 is exemplary in nature, and that in alternative embodiments, the data contained within the system database 120 may be organized in any other way.

A system database 120 may comprise one or more compute job result request 200 data records. Data of a compute job result request 200 may be provided by a job submitter 102 and may describe what computing, data manipulation, etc., the job submitter 102 desires that the system 100 should perform in exchange for some compensation that the job submitter 102 is willing to provide to the system 100.

A system database 120 may comprise one or more compute job resource 108 data records which may contain data describing a compute job resource 108. A compute job resource 108 may comprise any type of computing device (client device 400, server 300, computer, smartphone, smart appliance, data storage device or system, data/databases, and tradeable usage rights 114 backed resources 108, such as algorithm, logic, etc.) that performs a portion of the distributed computing to satisfy compute job results desired by a job submitter 102. This data may include a compute job resource identifier 109 data record and one or more computing properties 110 data records. A compute job resource identifier 109 may comprise any data unique to a compute job resource 108 for identification purposes, and may be used to confirm that a task result(s) 112 are provided by a compute job resource 108 that a computing task 111 was dispatched to (e.g. via some token or receipt). Computing properties 110 may contain data that may describe properties of compute job resources 108 which allow them to perform computing tasks 11, such as network communication speed, processor capacity, data storage capacity, etc.

A system database 120 may comprise one or more one or more computing tasks 111 data records which may comprise tasks (unit of work) assigned to the compute job resources 108. Generally, compute work of a job request 200 may be divided into a number of computing tasks 111 that may be communicated to one or more compute job resources 108.

A system database 120 may comprise one or more one or more task result 112 data records. Task results 112 may be generated by compute job resources 108 from performing computing tasks 111. Each task result 112 may comprise metadata 112A, such as file size, processing time or time to generate task result, file type, file name, compute job resource identifier 109 of the compute job resource 108 that generated the task result 112, etc.

A system database 120 may comprise one or more one or more compute job result 201 data records. A compute job result 201 may comprise data from one or more task results 112 that were generated by the performance of the computing tasks 111 generated for a compute job result request 200. Generally, a compute job result 201 may be formed by a collating a set of task results 112 into a compute job result 201.

A system database 120 may comprise one or more one or more resource cost 113 data records. A resource cost 113 may comprise data describing compensation that is to be provided to a compute job resource 108 or its owner (contributor user 101A) upon that compute job resource 108 generating a task result 112. In preferred embodiments, resource cost 113 may comprise compensation that is to be provided to a compute job resource 108 upon that compute job resource 108 generating a validated task result 112.

A system database 120 may comprise one or more one or more tradeable usage right 114 data records. A tradeable usage right 114 may comprise a data set, an algorithm, a software module, or other intellectual property that may be used by one or more compute job resources 108 to complete their computing tasks 111 and generate their task results 112. Each tradeable usage right 114 may comprise an identifier 114A which may be unique to the tradeable usage right 114 and/or to the contributor user 101A that provided the tradeable usage right 114. An identifier 114A may comprise an alphanumeric string or any other method of identifying a resource in a computing system.

A system database 120 may comprise one or more one or more tradeable usage right cost 115 data records. A tradeable usage right cost 115 may comprise data describing compensation that is to be provided by or through exchange for the usage right of the tradeable usage right 114 to the owner (usage right resource 101B) upon that tradeable usage right 114 being used by a compute job resource 108 for generating a task result 112.

A system database 120 may comprise one or more validation score 116 data records. Generally, a validation score 116 may comprise a value that system 100 determines for a compute job result 201 or task result 112 upon completing one or more validation tests for a compute job result 201 or task result 112, respectively.

A system database 120 may comprise one or more validation threshold 117 data records and/or rejection threshold 119 data records. A validation threshold 117 may comprise a value that a validation score 116 must meet or exceed to be considered valid, while a rejection threshold 119 may comprise a value that a validation score 116 must meet or be below to be considered invalid. A compute job result 201 may be provided to a job submitter 102 if the validation score 116 of the compute job result 201 or task results 112 meets or exceeds the validation threshold 117. In some embodiments, a job submitter 102 may have some influence on the validation threshold 117 but preferably cannot set it to prevent the job submitter 102 from setting the validation threshold 117 to some value or range that is unrealistic. In some embodiments, compute job result 201 or task results 112 results are accepted: if the validation score 116 is higher than the validation threshold 117 (automatic acceptance threshold); and/or if the validation score 116 is less than the validation automatic acceptance threshold 117 but greater than a validation automatic rejection threshold 119 and the job submitter 102 accepts the results based on the summary. In further embodiments, compute job result 201 or task results 112 results are rejected: if the validation score 116 is lower than the validation automatic rejection threshold 119; and/or if the validation score 116 is less than the validation automatic acceptance threshold 117 but greater than the validation automatic rejection threshold 119 and the job submitter 102 rejects the results based on the summary.

A system database 120 may comprise one or more job cost 118 data records. Generally, a job cost 118 may comprise the total cost of system 100 processing of a compute job result request 200 to generate the compute job result 201. A job cost 118 may comprise the resource costs 113 of compute job resources 108 that provided computing tasks 111 that contributed to the compute job result 201, tradeable usage right costs 115 incurred for generating a compute job result 201, and exchange and platform costs that a job submitter 102 may be required to provide to the system 100 in exchange for the compute job result 201.

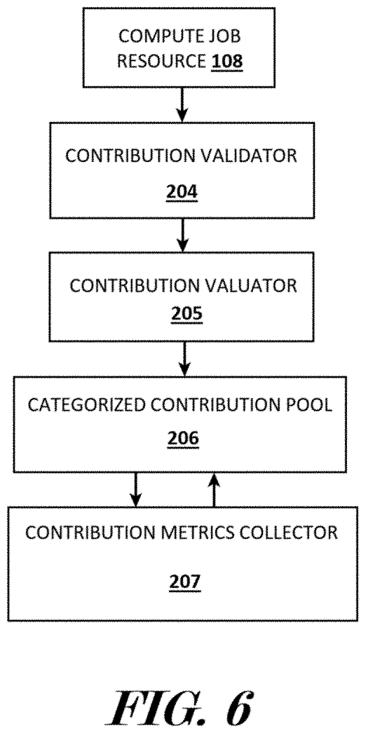

FIG. 6 illustrates some exemplary system 100 components which may be used to provide contribution registration for contributions (task results 112) provided by a compute job resource according to various embodiments. In some embodiments, a compute job resource 108 of a contributing user 101A submits a task result 112 (computing contribution) to the system 100 which may be a portion of the computing required for a computing job described in a compute job result request 200. The system 100 may comprise one or more computing properties 110 of the compute job resource 108 which may include data describing: device 400 availability for processing; device 400 storage or cloud storage capabilities; software of the device 400, such as modules, algorithms, and other code/technology; and data.

The contribution validator 204 may comprise a software engine which may receive the contribution from the compute job resource 108. In some embodiments, the contribution validator 204 may validate if the compute job resource 108 has the rights to submit the contribution. In further embodiments, the contribution validator 204 may validate the quality and/or performance of the contribution. In further embodiments, the contribution validator 204 may validate the capability and/or feature enumeration and categorization of the contribution. The contribution validator 204 may provide this data to a contribution valuator 205 which may comprise a software engine that may compute a relative static value of the task result 112 contribution based on feature and capabilities, preferably without including current market conditions. The contribution valuator 205 may provide this data to a categorized contribution pool database 206 in which the data may be used to group the contributing compute job resource 108, optionally with other contributing compute job resource 108, by type, capabilities, features, and preferably ranked by generated profiles and metrics. The data of the categorized contribution pool database 206 may be accessed and manipulated by a contribution metrics collector 207 which may comprise a software engine that may be configured for the generations and/or collection of compute job resource 108 profiles and the ranking of contributions.

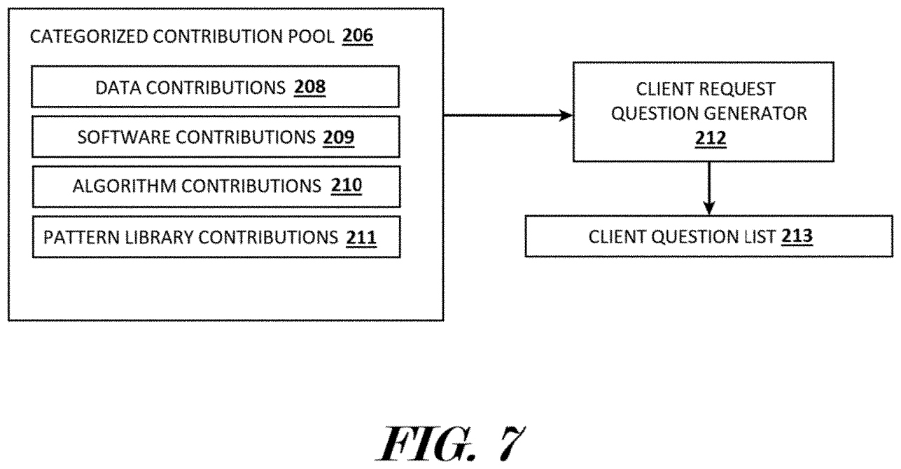

FIG. 7 depicts some exemplary system 100 components which may be used to provide one or more supported analytic request lists of client questions according to various embodiments. In some embodiments, a categorized contribution pool database 206 may include data for the one or more compute job resources 108 and computing jobs processed by the system 100 which may include contribution data records 208, software contribution data records 209, algorithm contribution data records 210, and pattern library contribution data records 211.

A client request question generator 212 software engine may access the data records 208, 209, 210, 211, and may be configured to combine contributions tagged in contribution pool 206 to generate a list of questions that the system 100 can provide analytic answers to. This list may be referred to as a client question list 213.

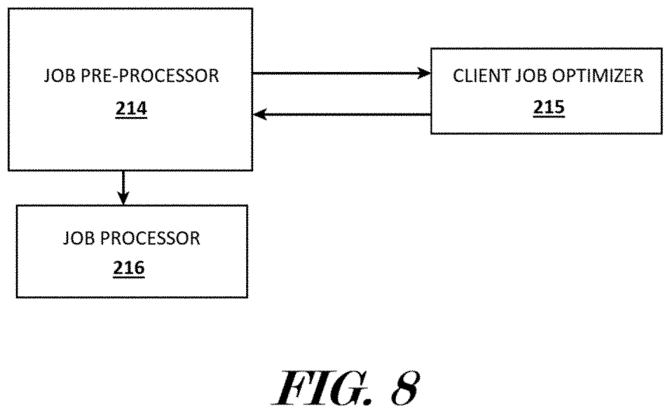

FIG. 8 shows some exemplary system 100 components which may be used to provide client job configuration and computing job pre-processing according to various embodiments. In some embodiments, a job pre-processor 214 software engine optionally running on the marketplace system 202 may present a client or job submitter 102 with a client question list 213 via a display screen of the client's or job submitter's 102 compute job resource 108. If the client or job submitter 102 provides input to the job pre-processor 214 for a question that is not in the client question list 213, the job pre-processor 214 may utilize a custom software module and/or custom data request which provides indication of interest to be dispatched to the marketplace. If the client or job submitter 102 provides input to the job pre-processor 214 for a question that is in the client question list 213, the job pre-processor 214 may receive data from the job submitter 102 that configures data for the computing job. This may include: job submitter 102 input selecting datasets from platform supplied data; job submitter 102 input providing their own data; and other data configuration such as time, location, etc. This missing data may be supplied to the custom software module and/or custom data request indication of interest dispatched to the marketplace 202. Next, the job pre-processor 214 may receive input from the job submitter 102 which allows the job submitter 102 to configure job dispatch characteristics, such as desired compute job resource 108 contributor qualities and desired time to get results. The job dispatch characteristics and other job data may then be provided to a client job optimizer 215 software engine which may use job characteristics and available contributions to rank “optimal” job execution plans, and the client job optimizer 215 may also interface with the marketplace 202 to price job execution plans. This data may then be returned to the job pre-processor 214 and presented to the job submitter 102 to allow the job submitter 102 to select job plan based on price and time considerations. The select job plan may then be provided to a job processor 216 software engine. If no job execution plan is acceptable to the job submitter 102, the job pre-processor 214 may provide device availability indication of interest to the marketplace 202.

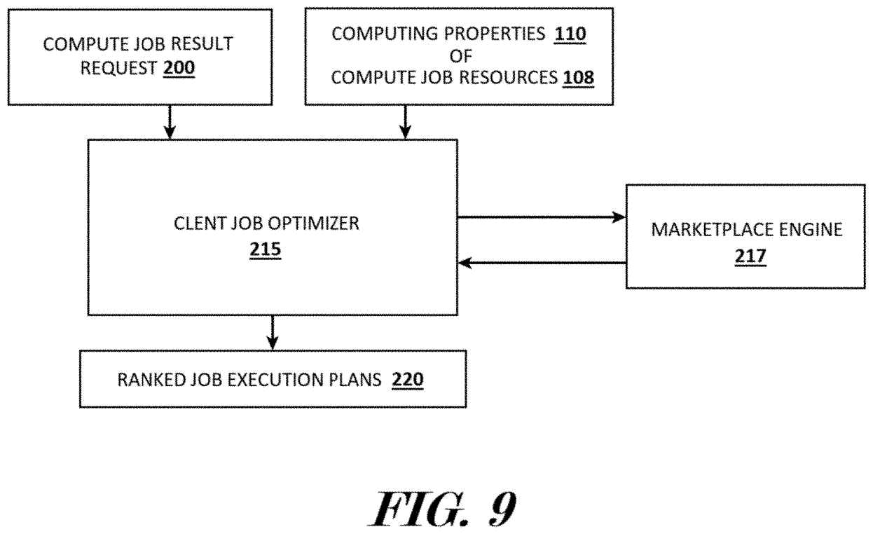

FIG. 9 depicts a flow diagram that a client job optimizer software engine may perform to generate ranked computing job execution plans according to various embodiments. In some embodiments, a client job optimizer 215 may receive a compute job result request 201 having data describing a configuration description for a computing job from a client or job submitter 102. Computing property 110 data of one or more compute job resources 108, which may include such as device availability profile data, device capabilities/profile data, device “network location” profile data, etc. may also be received by the client job optimizer 215 optionally from the categorized contribution pool database 206.

The client job optimizer 215 may then filter available contributions based on job request configuration (for example, desired compute job resources 108, required data or software modules of the compute job resources 108, etc.) which may be used by the client job optimizer 215 to estimate duration of the computing job. The client job optimizer 215 may create distributed computing network 107 maps of desired/available contributions for the estimated duration of the computing job. Preferably, the client job optimizer 215 may cluster compute job resources 108 to perform related tasks (multiple tasks make up a computing job). Preferably, the client job optimizer 215 may cluster compute job resources 108 in logical proximity to data needed for task(s). The client job optimizer 215 may then create task redundancy map based on the distributed computing network 107 maps to add job completion resilience. The client job optimizer 215 may then calculate computing task 111 dispatch order and device communication requirements and timing to complete execution plan(s). The client job optimizer 215 may provide the proposed execution plans to a marketplace portal 217. A marketplace software engine 217 may determine the real time pricing for the computing job based on contributions needed for the job, contributions availability, and other supply/demand metrics. Pricing may be calculated as: statistically defined price, auction, reverse auction, bid/ask spread match, or any other suitable means. The execution plan pricing data then may be provided to the client job optimizer 215 which may then aggregate/rank possible execution plans, and the client job optimizer 215 may output ranked job execution plans 220, including prices and estimate execution times.

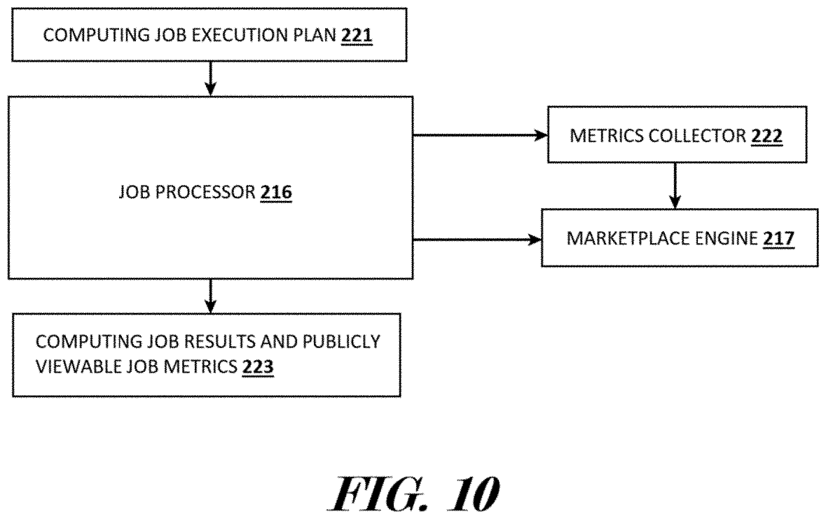

FIG. 10 depicts a flow diagram that a job processor software engine 216 may perform to generate compute job results or answers and publicly viewable job metrics according to various embodiments. In some embodiments, a job processor 216 may receive data describing a computing job execution plan 221, such as which may be generated by the client job optimizer 215 as discussed in FIG. 8, that may optionally be selected by a job submitter 102.

The job processor 216 may then generate data payloads with data needed for device work clusters, and the job processor 216 may index and encrypt data payloads so that any compute job resource 108 can only locate and decrypt data intended for that compute job resource 108. The data may then be deployed by the job processor 216 to location logistically close to or inside of one or more work clusters of compute job resources 108. The job processor 216 may then dispatch computing tasks 111 having job task execution information, such as data location, index, encryption key, execution commands, software modules to use, public data to use, etc., to the compute job resources 108.

The compute job resources 108 may then process the computing tasks 111 and send the resulting task results 112 to a metrics collector 222 software engine. Generally, as computing tasks 111 or groups of computing tasks 111 are completed by compute job resources 108 information about tasks/job may be published to the metrics collector 222 for task information aggregation and storage. The metrics collector 222 may then provide this information to the marketplace engine 217, and the marketplace engine 217 may provide contribution performance, efficiency, availability, location, and other data which can be used to determine real time price of computing job and payment to contributors and which also may be used by the market place engine 217 for the pricing of future compute jobs.

The compute job resources 108 may provide the task results 112 which may be aggregated by the job processor 216, optionally aggregation may be done by compute job resources 108 or by system servers 300. Next, the job processor 216 may collect payment from the job submitter 102. The job processor 216 may pay job-based contributions (software/data) and payment may be made to “availability pool” for availability-based contributions and this data may also be provided to the marketplace engine 217. The job processor 216 may then output the computing job results (answers) and publicly viewable job metrics 223 of the computing job.

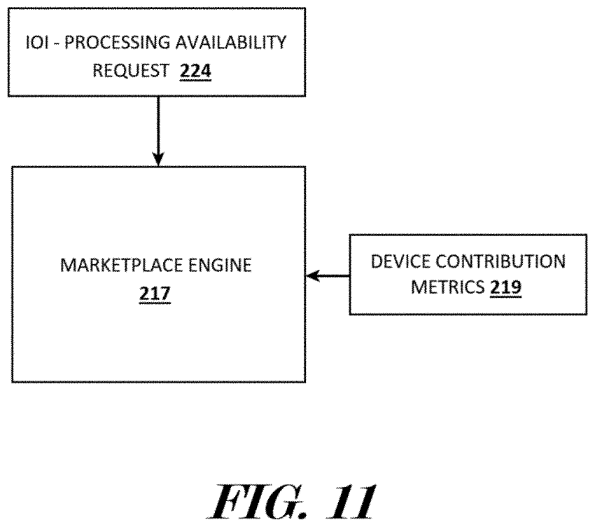

FIG. 11 shows a flow diagram of an example process that a marketplace engine 217 may use to determine or receive indications of interest (IOI) from compute job resources 108 for generating a task results 112 for a compute job result 201 and to determine a price for the computing job results 201 according to various embodiments. The marketplace engine 217 may follow similar protocols for data requests, software requests, storage requests, etc. In some embodiments, the marketplace engine 217 may receive a processing availability request 224. The marketplace engine 217 may publish availability request to the job resources and/or to the owners of the resources. The marketplace engine 217 may then publish availability request to compute job resources 108 and/or contributor users 101A with the potential for an additional add-on price for availability based on past device contribution metrics 219. Additionally, the marketplace engine 217 may receive device contribution metrics 219, such as device performance profiles, device logical location profiles, and device past jobs. Next, the marketplace engine 217 may create auction, reverse auction, bid-ask spread book, etc., to allow marketplace to define a fair-market price for the processing availability request 224.

In some embodiments, a marketplace engine 217 may perform payment settlement or compensation to the job resources, such as via a Competition system, pay for available hour(s), pay for use, rights to use shares, etc. In further embodiments, a marketplace engine 217 may determine or receive indications of interest (IOI) functions for contribution(s) that may be provided by a distributed computing network 107 of compute job resources, such as IOI validation, IOI publication, IOI management, etc. In further embodiments, a marketplace engine 217 may determine pricing for things such as client jobs, premium contributions, contribution static value, contribution real-time value, rights to use shares, etc. In still further embodiments, a marketplace engine 217 may perform rights to use share creation.

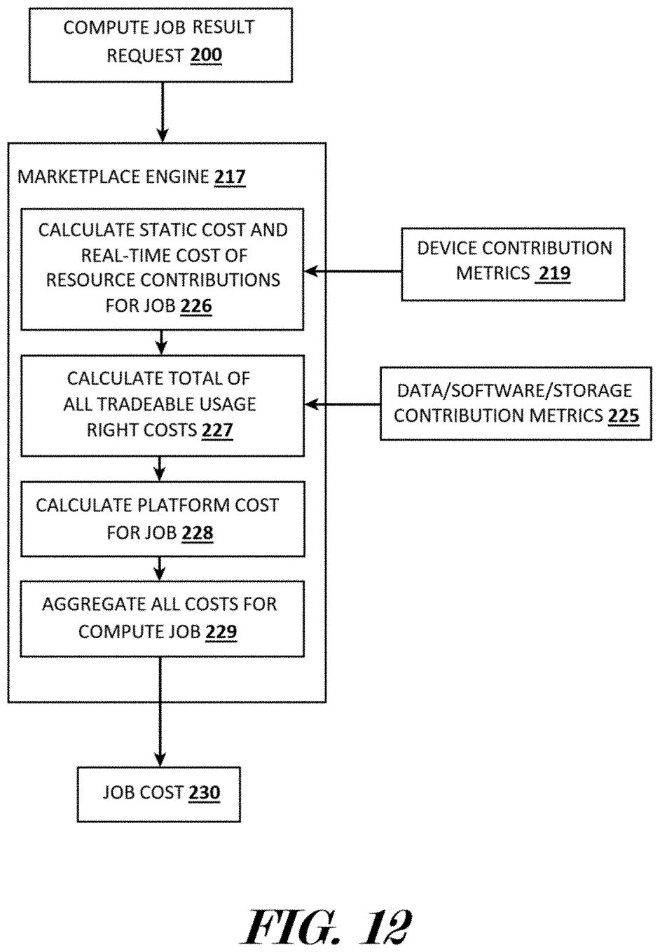

FIG. 12 shows a flow diagram of an example process that a marketplace engine 217 may use to determine a cost for generating a compute job result 201 for a compute job result request 200 according to various embodiments. In some embodiments, the marketplace engine 217 may receive a compute job result request 201. The marketplace engine 217 may then receive device contribution metrics 219 that includes computing properties 110 of the compute job resources 108, such as device performance profiles, device capabilities, device logical location profiles, device add-on pricing, and contributor add-on pricing. The marketplace engine 217 may use these metrics to calculate a static cost and a real-time cost of the compute job resources 108 contributions for the compute job in step 226. Next, the marketplace engine 217 may receive data, software, and/or storage contribution metrics 225 which may include performance profiles, storage logical location profiles, contributor add-on pricing, etc. The marketplace engine 217 may then use these data, software, and/or storage contribution metrics 225 to calculate a cost for all tradeable usage right(s) 108, such as data, software, storage, etc., that may be needed for the compute job of the compute job result request 200 in step 227. Next, the marketplace engine 217 may calculate a platform cost for the job in step 228 which may include profit margin and other system 100 administration costs. Finally, the marketplace engine 217 may total these costs to generate a job cost 230 in step 229 that the job submitter 102 may be required to pay for the compute job result 201.

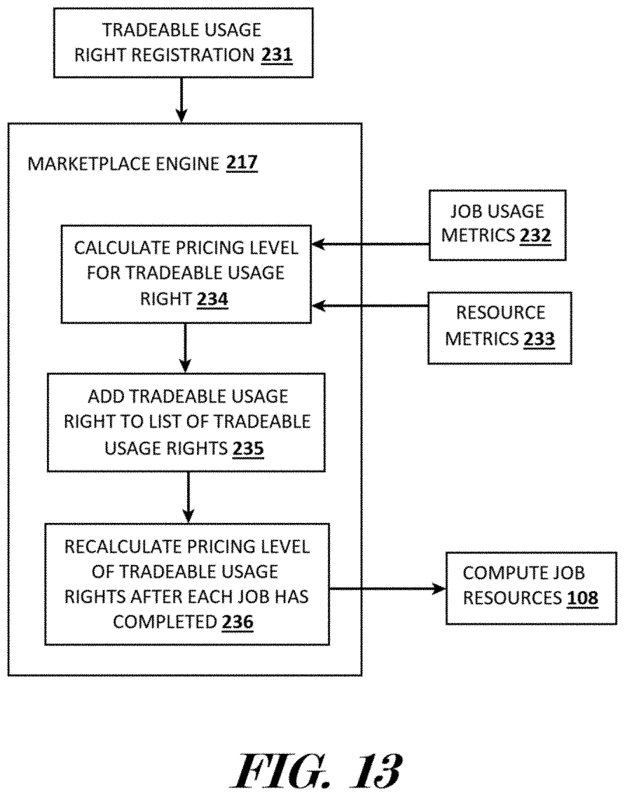

FIG. 13 shows a flow diagram of an example process that a marketplace engine 217 may use to register tradeable usage rights 114 which may be used by one or more compute job resources 108 for the generation of task results 112 according to various embodiments described herein. In some embodiments, a tradeable usage right 114 may be provided or registered 231 to the marketplace engine 217. The marketplace engine 217 may then receive job usage metrics 232 and resource metrics 233. Job usage metrics 232 may comprise data describing the number of compute jobs 200 that may be suitable for using the tradeable usage right 114, the number of compute jobs 200 waiting for the use of the tradeable usage right 114, the number of times that the tradeable usage right 114 has been used by the system 100, etc. Resource metrics 233 may comprise data describing the number of compute job resources 108 that can use or support the tradeable usage right 114. The marketplace engine 217 may then use the data of these metrics 232, 233, to calculate a pricing level for the tradeable usage right 114 in step 234. For example, higher to lower pricing levels may be named gold, silver, bronze, etc. In step 235, the marketplace engine 217 may add the tradeable usage right 114 to a published, searchable list of tradeable usage rights 114 having a description of the capabilities of the tradeable usage rights 114. In some embodiments, the marketplace engine 217 may recalculate the pricing level of one or more, and more preferably all, tradeable usage rights 114 after each job has completed in step 236. The compute job resources 108 of the system 100 may manually customize their account to select and purchase specific tradeable usage rights 114, preferably using right-to-use share. In further embodiments, compute job resources 108 may subscribe to the tradeable usage rights 114 marketplace provided automatic-premium level. Optionally, as tradeable usage rights 114 switch premium or pricing levels, they may be automatically available to compute job resources 108 and usage right resources 101B that have subscribed at the level or lower (e.g. gold subscription gets gold, silver, and bonze pricing level tradeable usage rights 114.

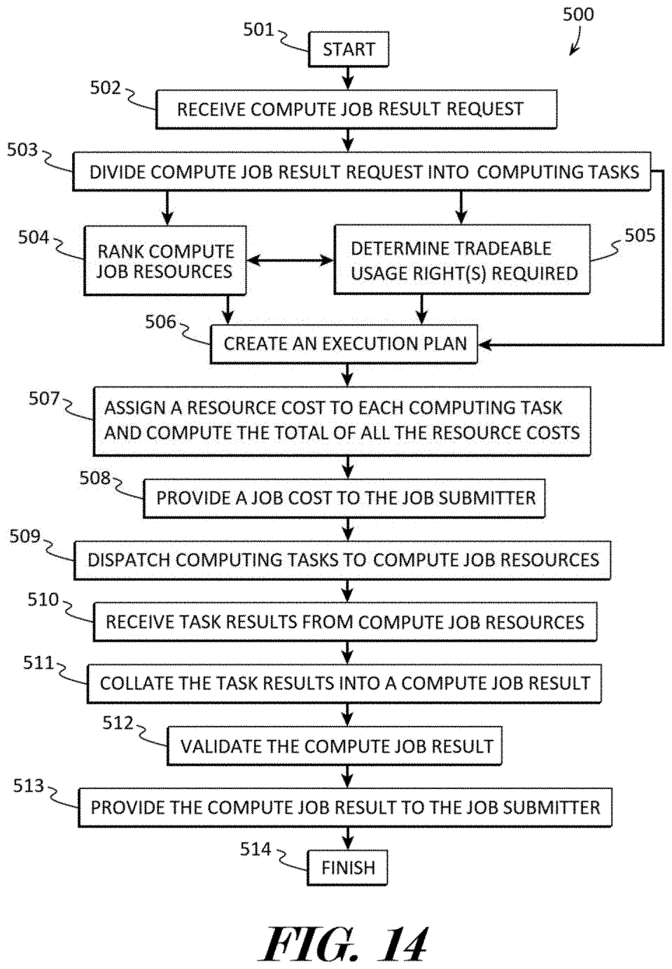

FIG. 14 shows a block diagram of an example of a computer-implemented method for providing a job cost and a validated compute job result to a job submitter (“the method”) 500 according to various embodiments described herein. In some embodiments, the method 500 may be used to provide validated compute job results 201 that satisfy a compute job result request 200 and job cost 118 for the compute job results 201 to a job submitter 102. One or more steps of the method 500 may be performed by processor logic, such as a marketplace system 202, a contribution validator 204, a contribution valuator 205, a contribution metrics collector 207, a client request question generator 212, a job pre-processor 214, a client job optimizer 215, a job processor 216, a marketplace engine 217, a metrics collector 222, and/or any other suitable processor logic.

In some embodiments, the method 500 may start 501 and a compute job result request 200 may be received by the system 100 in step 502. The compute job result request 200 may be input by a job submitter 102 and may comprise data describing computing, data manipulation, etc., that the job submitter 102 or buyer desires to be completed by the system 100.

In step 503, processor logic may divide compute job result request 200 into a plurality of computing tasks 111 which may be suitable for being performed by one or more, such as a plurality of, compute job resources 108 in a distributed computing network 107. The computing tasks 111 may comprise tasks or unit of work that may be assigned to the compute job resources 108, and the totality of the computing tasks 111 may satisfy the computing, data manipulation, etc., desired by the job submitter 102 as described in the compute job result request 200.

In some embodiments, after step 503 the method 500 may proceed to step 506. In further embodiments, after step 503 the method 500 may proceed to step 504 and/or 505 before proceeding to step 506.

In optional step 504, processor logic may rank compute job resources 108 of the system 100. In some embodiments, processor logic may rank each compute job resource 108 based one or more computing properties 110 of each compute job resource 108, such as network communication speed, processor capacity, data storage capacity, memory capacity, and network proximity of each compute job resource 108 to other compute job resources 108.

In optional step 505, processor logic may determine one or more tradeable usage rights 114 that may be required for the compute job result request 200 in which each tradeable usage right 114 may have a tradeable usage right cost 115. In preferred embodiments, a tradeable usage right 114 may comprise a data set, an algorithm, and/or a software module.

In step 506, processor logic may create an execution plan 221 which maps each computing task 111 to one or more compute job resources 108. A computing task 111 may be assigned to one or more compute job resources 108 based on the ability of the compute job resources 108 to perform the computing task 111 according to their respective computing properties 110.

In step 507, processor logic may assign a resource cost 113 to each computing task 111 and compute the total of all the resource costs 113. A resource cost 113 may describe compensation that is to be provided to compute job resource(s) 108 for generating a task result 112 by completing a computing task 111.

In step 508, processor logic may provide a job cost 118 to the job submitter 102, such as by electronically communicating the job cost 118 to a client device 400, compute job resource 108, etc., of the job submitter 102. A job cost 118 may describe the total cost of system 100 processing the compute job result request 200 to generate the compute job result 201. In some embodiments, the job cost 118 may include the total of all the resource costs 113 generated in step 507. In further embodiments, the job cost 118 may include the total of all tradeable usage right costs 115 that may be used by compute job resource(s) 108 for generating a task result 112 by completing a computing task 111. In still further embodiments, the job cost 118 may include the system 100 or platform costs, such as administration costs, profit margins, and other costs incurred by the system 100.

In step 509, processing logic may dispatch the plurality of computing tasks 111 to the mapped compute job resources 108 via the distributed computing network 107. In preferred embodiments, the processing logic may dispatch the plurality of computing tasks 111 to the mapped compute job resources 108 after the job submitter 102 has accepted the job cost 118 provided to the job submitter 102 in step 508.

In step 510, processing logic may receive task results 112 from the mapped compute job resources 108 via the distributed computing network 107. In some embodiments, after a task result 112 is received from a mapped compute job resource 108 from performing a computing task 111, the resource cost 113 for the computing task 111 may be provided to the compute job resource 108 that provided the compute job result 112.

In step 511, processing logic may collate the task results 112 into a compute job result 201. Generally, the compute job result 201 is the compute result that is outputted to satisfy compute job results for the buyer's compute job result request 200.

In step 512, processing logic may validate the compute job result 201. In some embodiments, processing logic may validate the compute job result 201 by validating one or more of the task results 112 received from one or more of the compute job resources 108. In further embodiments, each task result 112 may comprise metadata 112A describing the task result 112A, and the metadata 112A may be used to validate each one task result 112. Preferably, the metadata 112A may include one or more of file size, file type, time to generate task result 112, and compute job resource identifier 109. In further embodiments, processing logic may receive task results 112 is step 510 and may store them for a set of validation tests to determine the validation score 116 for the task results 112. Based on the outcome of the completed validation tests, the processing logic assigns the task results 112 and/or the compute job result 201 generated from the task results 112 a validation score 116. For example, the system 100 may confirm the task results 112 are provided by a compute job resource 108 that the computing task 111 was dispatched to (e.g. via a token or receipt). As another example, the system 100 may confirm the file type metadata 112A of the task result 112 matches an approved file type (e.g. no JPEG files for numerical analysis). As another example, the system 100 may compare the task results 112 to other task results 112 that have been previously completed for similar compute job result requests 200, such as by comparing metadata 112A, file size, processing time, etc., of the task results 112. As another example, the system 100 may review the size of the task result 112 files returned, such that too small and too large file sizes may indicate invalid task result 112. As another example, if the job submitter 102 has defined result requirements in their compute job result request 200, the compute job result 201 will be measured against those requirements, such as if the job submitter 102 has defined the format of the results (e.g. 1 value per month) then the compute job result 201 could not contain more than 12 data points per year, if the job submitter 102 stated the analysis needed to have at least 5 years of a certain type of data then the system 100 may count the number of input data points. As another example, the system 100 may system record the time it takes for a compute job resource 108 to return task result(s) 112. As another example, the system 100 may selectively dispatch a single computing task 111 to multiple compute job resources 108 in order to identify ‘bad actors’. As another example, the system 100 may monitor past performance of compute job resources 108 participating via providing task results 112 for generating a compute job result 201. As another example, the system 100 may monitor past performance of a compute job resource 108 participating in generating a compute job result 201. As another example, the system 100 may do quality assurance based on the type of results (e.g. if the analysis is in regards to solar farm generation, the results should show a correlation with the rising and setting of the sun). This may be accomplished by the input dataset of a compute job result request 200 requiring metadata tags to categorize the type of data the job submitter 102 requests. The system 100 may register the type of analysis requested by the job submitter 102 and would apply particular quality assurance tests for a given type of analysis. These may include keyword search, natural language processing, AI, checking for blank values and/or errors in the data (an example error may be that the hour of day is recorded as 25, but since there are only 24 hours in a day the system 100 can recognize there is an error). Additionally, some domains have certain patterns, such as seasonality, that be validated against.

In some embodiments, processing logic may validate the compute job result 201 by validating one or more of the tradeable usage rights 114 which may be used by one or more of the compute job resources 108 in the generation of task results 112. In preferred embodiments, processing logic may validate a tradeable usage right 114 if the processor logic determines one or more of the following: that the tradeable usage right 114 is not duplicated in the system 100, that the tradeable usage right 114 is not owned by two different parties or usage right resources 101B; that a capability of the tradeable usage right 114 is actually true, and that the tradeable usage right 114 is not associated with repeated low validation scores 116 of other task results 112 and which used the tradeable usage right 114, and that the tradeable usage right 114 is not associated with repeated low validation scores 116 of other compute job results 201 which used the tradeable usage right 114.

In further embodiments, the system 100 registers the underlying intellectual property of a tradeable usage right 114 (e.g. data, algorithm or software module) associated with the requested tradeable usage right 114. The system 100 provides a range for the quantity of tradeable usage rights 114 and a range for the price or cost of the tradeable usage rights 115. Once the contributor user 101A that is the owner of the tradeable usage right 114 selects their quantity and price, the system 100 confirms both are within the allowable range. The system 100 may then registers each tradeable usage right 114 with a unique identifier in order to track the authenticity of the tradeable usage right 114 in future time periods. In further embodiments, the system 100 validates that there are no duplicate tradeable usage rights 114. Each tradeable usage right 114 may have a unique identifier, allowing the system to check that there are no other tradeable usage rights 114 with the same identifier, and that each underlying IP (data/software module/algorithm) have a defined number of tradeable usage rights 114 at any given time. The system 100 may ‘stamp’ each tradeable usage right 114 at the time of transaction to let buyers/sellers know it has been audited for authenticity. One option for this is to use the blockchain, or similar technology, to maintain proof of chain of ownership.

In some embodiments, the system 100 may validate a tradeable usage right 114 by verifying that no two parties or usage right resources 101B own the same tradeable usage right 114.

In some embodiments, the system 100 may validate a tradeable usage right 114 by periodically auditing the underlying intellectual property associated with a tradeable usage right 114 to validate the capability represented is actually true. For data type tradeable usage right 114, the method or explanation of the background is required to be submitted to the system 100 upon request so it can be duplicated and/or verified. For algorithms type tradeable usage right 114, it may be the end result that needs to be verified (whether it works), but not the steps itself. This These audits may be random, by Competition system, targeted to job submitters 102 new to the system 100, or via any other method. As tradeable usage right 114 is developed more of the instances will be improvements on existing and then the previous implementations can be used for audit purposes.

In some embodiments, the system 100 may validate a tradeable usage right 114 by identifying repeated task result 112 failures and/or repeated low validation scores of computing tasks 111 which use a particular tradeable usage right 114.

In some embodiments, the system 100 may validate a tradeable usage right 114 by monitoring the past performance of a contributor user 101A.

In some embodiments, if a tradeable usage right 114 is replacing an existing one (perhaps due to better performance) then these will be compared to validate the tradeable usage right 114.

In some embodiments, the system 100 may validate a tradeable usage right 114 by confirming the contributor user 101A or submitter has a valid email address, cell phone number, corporate email address, valid cloud account (ex. Google Cloud, Amazon Web Services, Microsoft Azure, etc.), valid GitHub account with a reasonable amount of past activity, developer account(s) with Apple, Amazon Web Services, Microsoft Azure, Google Cloud etc.

In some embodiments, the system 100 may validate a tradeable usage right 114 by validating receipt of payment by contributor user 101A or submitter that is required to register their tradeable usage right 114 (data/algorithm/software module) prior to creation of new tradeable usage rights 114.

In some embodiments, the system 100 may validate a tradeable usage right 114 by testing the data/software module/algorithm of the tradeable usage right 114 using predefined data and known results that the proposed data/software module/algorithm can be validated against.

In some embodiments, processing logic may validate the compute job result 201 by assigning a validation score 116 to the compute job result 201. A validation score 116 may be generated by one or more of the above validation methods for the task results 112 and/or tradeable usage rights 114 that were used by the compute job resources 108. In some embodiments, the system 100 may comprise a validation threshold 117, and the compute job result is provided to the job submitter 102 in step 512 if the validation score 116 is at least equal to the validation threshold 117. For example, the compute job result 201 may be accepted: if the validation score 116 is higher than the validation automatic acceptance threshold 117; and/or if the validation score 116 is less than the validation automatic acceptance threshold 117 but greater than the validation automatic rejection threshold 117 and the job submitter 102 accepts the results based on a summary or other description of the compute job result 201. As another example, the compute job result 201 may be rejected: if the validation score 116 is lower than the validation automatic rejection threshold 117; and/or if the validation score 116 is less than the validation automatic acceptance threshold 117 but greater than the validation automatic rejection threshold 117 and the job submitter 102 rejects the results based on a summary or other description of the compute job result 201.

In preferred embodiments, electronic access to a tradeable usage right 114 may be provided to a compute job resource 108 for use in generating a task result 112 after the tradeable usage right 114 has been validated. In further embodiments, this electronic access may provide the compute job resource 108 the ability to use tradeable usage right 114. In further embodiments, this electronic access may provide the compute job resource 108 and/or the usage right resource 101B of the tradeable usage right 114 with the ability to transfer (transferability) the tradeable usage right 114 to another compute job resource 108 or other entity of the system 100.

In step 513, processing logic may provide the compute job result 201 to the job submitter 102, such as by communicating the compute job result 201 to the client device 400 of the job submitter 102. After step 513, the method 500 may finish 514.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random-access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or WIFI network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device or client device such as a personal digital assistant (PDA), laptop computer, tablet computer, smartphone, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1) A computer-implemented computing valuation system for the posting and transfer of computing jobs, the system comprising:
a) a job submitter providing a compute job result request;
b) a plurality of compute job resources each having a computing property; and
c) processor logic configured to:
divide the compute job result request into a plurality of computing tasks;
create an execution plan which maps each computing task to at least one compute job resource of the plurality of compute job resources based on their respective computing property;
assign a resource cost to each computing task and compute the total of all the resource costs;
provide a job cost to the job submitter;
dispatch the plurality of computing tasks to the mapped at least one compute job resource;
receive task results from the mapped at least one compute job resource;
collate the task results into a compute job result;
validate the compute job result; and
provide the compute job result to the job submitter.

2) The computer implemented system of claim 1, wherein the resource cost for a computing task is provided to the compute job resource that provided the compute job result for that computing task.

3) The computer implemented system of claim 1, wherein the compute job result is validated by assigning a validation score to the compute job result.

4) The computer implemented system of claim 3, further comprising a validation threshold, and wherein the compute job result is provided to the job submitter if the validation score is at least equal to the validation threshold.

5) The computer implemented system of claim 1, wherein the compute job result is validated by validating at least one task result.

6) The computer implemented system of claim 5, wherein the at least one task result comprises metadata, and wherein the metadata is used to validate the at least one task result.

7) The computer implemented system of claim 6, wherein the metadata used to validate the at least one task result comprises at least one of: file size, file type, time to generate task result, and compute job resource identifier.

8) The computer implemented system of claim 1, wherein the job cost includes the total of all the resource costs.

9) The computer implemented system of claim 8, wherein the job cost includes a tradeable usage right cost.

10) The computer implemented system of claim 1, wherein the processor logic is configured to rank each compute job resource based on at least one computing property of each compute job resource, the at least one property selected from network communication speed, processor capacity, data storage capacity, memory capacity, and network proximity of each compute job resource to other compute job resources.

11) A computer-implemented computing valuation system for the posting and transfer of computing jobs, the system comprising:
a) a job submitter providing a compute job result request;
b) a plurality of compute job resources each having a computing property; and
c) processor logic configured to:
divide the compute job result request into a plurality of computing tasks;
determine at least one tradeable usage right that is required for the compute job result request, the at least one tradeable usage right having a tradeable usage right cost;
create an execution plan which maps each computing task to at least one compute job resource of the plurality of compute job resources based on their respective computing property;
assign a resource cost to each computing task and compute the total of all the resource costs;
provide a job cost to the job submitter, the job cost including the total of all the resource costs and the tradeable usage right cost of the at least one tradeable usage right;
dispatch the plurality of computing task to the mapped at least one compute job resource;
receive task results from the mapped at least one compute job resource;
collate the task results into a compute job result;
validate the compute job result; and
provide the compute job result to the job submitter.

12) The computer implemented system of claim 11, wherein the at least one tradeable usage right comprises at least one of: a data set, an algorithm, and a software module.

13) The computer implemented system of claim 12, wherein the processor logic is configured to validate the at least one tradeable usage right.

14) The computer implemented system of claim 13, wherein the at least one tradeable usage right is validated if the processor logic determines at least one of the following: that the at least one tradeable usage right is not duplicated, that the at least one tradeable usage right is not owned by two different usage right resources; that a capability of the at least one tradeable usage right is actually true, and that the at least one tradeable usage right is not associated with repeated low validation scores of other task results which used the at least one tradeable usage right, and that the at least one tradeable usage right is not associated with repeated low validation scores of other compute job results which used the at least one tradeable usage right.

15) The computer implemented system of claim 13, wherein electronic access to the at least one tradeable usage right is provided to a compute job resource for use in generating a task result after the at least one tradeable usage right has been validated.

16) The computer implemented system of claim 15, wherein the tradeable usage right cost of the at least one tradeable usage right is provided to a usage right resource that provided the at least one tradeable usage right.

17) The computer implemented system of claim 11, wherein the compute job result is validated by assigning a validation score to the compute job result.

18) The computer implemented system of claim 17, further comprising a validation threshold, and wherein the compute job result is provided to the job submitter if the validation score is at least equal to the validation threshold.

19) The computer implemented system of claim 11, wherein the compute job result is validated by validating at least one task result.

20) The computer implemented system of claim 19, wherein the at least one task result comprises metadata, and wherein the metadata is used to validate the at least one task result.
